(19) United States
(12) Patent Application Publication
(10) Pub. No.: US 2004/0222569 A1
(43) Pub. Date: Nov. 11, 2004

(54) Apparatus for making leak-proof containers

(76) Inventor: Durell Thomas Mader, East Stroudsburg, PA (US)

Correspondence Address: Durell Thomas Mader, P. O. Box 28, East Stroudsburg, PA, 18301-0028, US

(21) Appl. No.: 10/614,318

(22) Filed: May 5, 2003

(51) Int. Cl. B29C 51/10

(52) U.S. Cl. 264/516

(57) ABSTRACT

An apparatus to insert a film liner inside a paper container which holds liquids or solid material of light or heavy viscosities. Container has an inner film liner which conforms to the configuration of an outer paper container, and is secured to the open end, the side wall, and the bottom of the outer container. The shape of the outer container may be (but not limited to) round, square, or rectangular.

The apparatus inserts a plastic film into the container, rewgardless of the shape of the container with the use of heat and vacuum, thus creating a container that is leak-proof and environmentally friendly, and is not adversely affected by microwave nor freezing temperatures.

### BRIEF DESCRIPTION

An apparatus for installing a film liner into an existing container. The container will satisfy food packaging and medical requirements as the film is non-toxic and is not detrimentally affected by microwave nor freezing temperatures.

### DESCRIPTION OF THE FIGURES OF THE DRAWINGS

FIG. 1 is a plan view of the lined container

FIG. 2 is a sectional elevation of the lined container.

FIG. 3 is a plan view of the apparatus,

FIG. 4 is an elevation of the apparatus.

FIG. 5 is a vertical cross section of the apparatus.

FIG. 6 is a plan view of the container support.

FIG. 7 is an elevation of the container support.

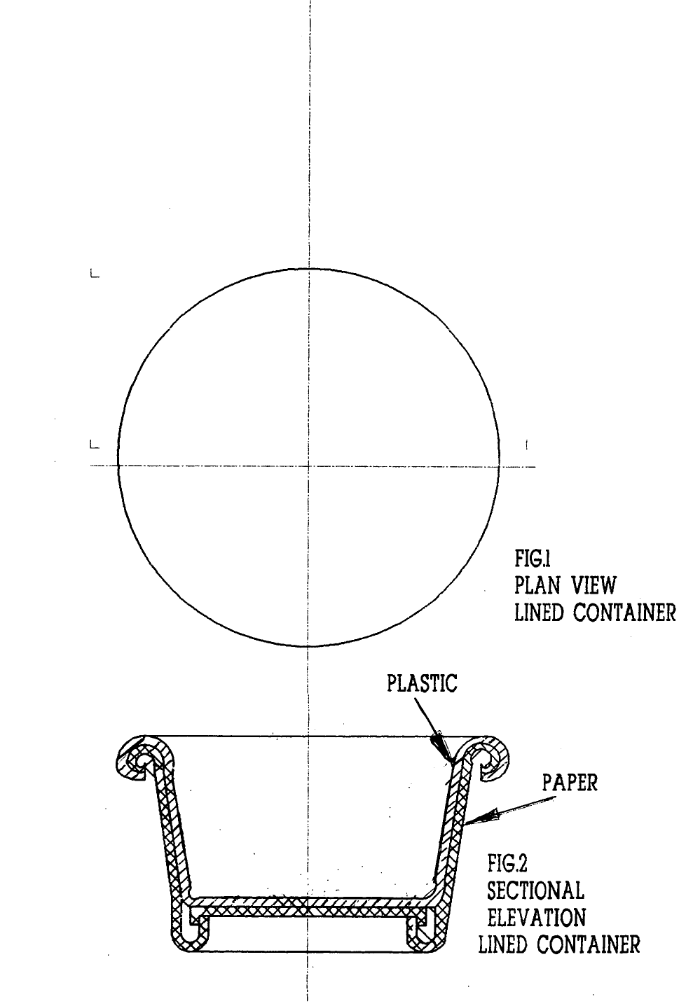

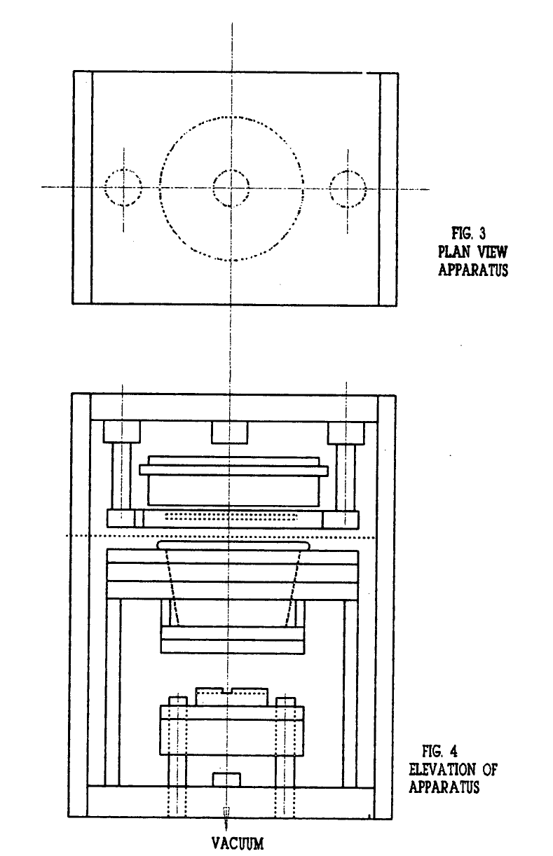

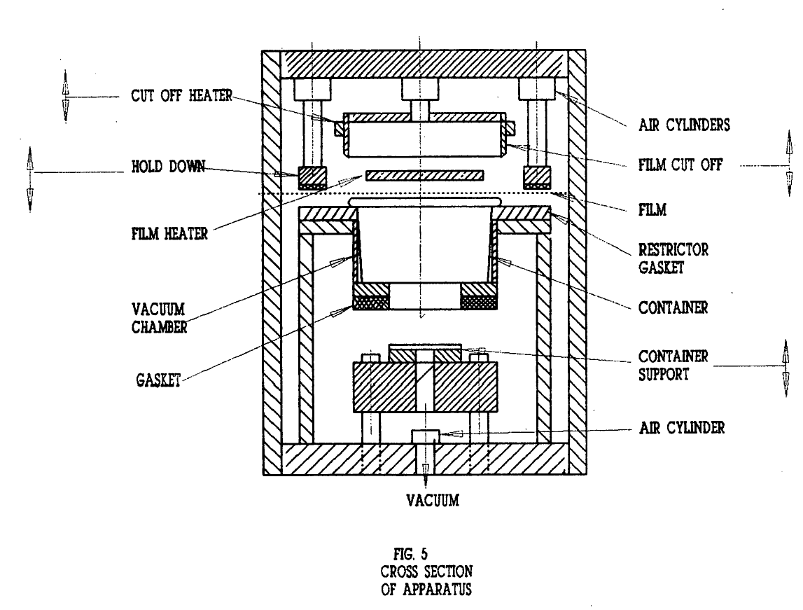

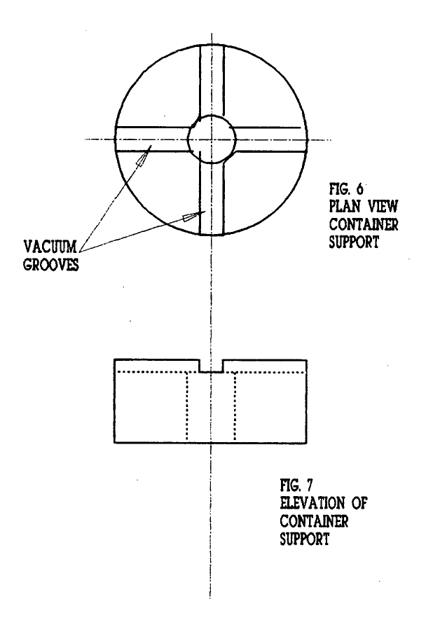

1. I claim a method to produce a non-toxic, bio-degradable, leak-proof container which is not adversely affected by microwave nor freezing temperatures, by inserting a film liner inside the container, which adheres to the inner surfaces of the container without any additional material.
